(19) United States
(12) Patent Application Publication
(10) Pub. No.: US 2024/0097160 A1
(43) Pub. Date: Mar. 21, 2024

(54) FUEL CELL SYSTEM AND VEHICLE

(71) Applicant: ISUZU MOTORS LIMITED, Yokohama-shi (JP)

(72) Inventors: Takatada USAMI, Fujisawa-shi (JP); Daichi SHIBUYA, Fujisawa-shi (JP)

(21) Appl. No.: 18/232,183

(22) Filed: Aug. 9, 2023

(30) Foreign Application Priority Data
Sep. 16, 2022 (JP) 2022-148081

(51) Int. Cl. H01M 8/04111; B60L 50/72; B60L 58/33; H01M 8/04007

(52) U.S. Cl. CPC H01M 8/04111; B60L 50/72; B60L 58/33; H01M 8/04067; H01M 2250/20

(57) ABSTRACT

Provided are a fuel cell system and a vehicle that can improve the power recovery efficiency in a supercharger of a fuel cell vehicle. A fuel cell system according to an aspect of the present disclosure includes: a fuel cell; a supercharger configured to increase a pressure of intake air of the fuel cell by rotating a turbine with an exhaust of the fuel cell; and a heat pump apparatus configured to absorb heat from a predetermined heat source to increase a temperature of the exhaust supplied to the turbine.

### CROSS REFERENCE TO RELATED APPLICATIONS

This application is entitled to and claims the benefit of Japanese Patent Application No. 2022-148081, filed on Sep. 16, 2022, the disclosure of which including in this specification, drawings and abstract is incorporated herein by reference in its entirety.

### TECHNICAL FIELD

The present disclosure relates to a fuel cell system for running by using the power generated by a fuel cell, and a vehicle.

### BACKGROUND ART

Fuel cell systems have been developed that generate power by causing a reaction between oxygen in the atmosphere and fuel gas (such as hydrogen) and use the generated power to generate driving force. In such fuel cell systems, a supercharger (turbocharger) with a turbine that is rotated by the exhaust from the fuel cell has been developed to recover power from the exhaust.

For example, Japanese Patent Application Laid-Open No. 2021-141055 discloses a cooling system for a fuel cell vehicle that cools supercharged intake air from a turbocharger and supplies it to a fuel cell, and is a technique for preventing the cooling section from becoming too hot.

### SUMMARY OF INVENTION

### Technical Problem

Depending on the type of fuel cell, the operating and exhaust temperatures may be as low as around 100° C. When such fuel cells are used, the temperature difference between the exhaust and the atmosphere is small, making it difficult to achieve sufficient power recovery in the supercharger.

An object of the present disclosure is to provide a fuel cell system and a vehicle that can improve the power recovery efficiency in a supercharger of a fuel cell vehicle.

### Solution to Problem

A fuel cell system according to an aspect of the present disclosure includes: a fuel cell; a supercharger configured to increase a pressure of intake air of the fuel cell by rotating a turbine with an exhaust of the fuel cell; and a heat pump apparatus configured to absorb heat from a predetermined heat source to increase a temperature of the exhaust supplied to the turbine.

A vehicle according to an aspect of the present disclosure is equipped with the above-described fuel cell system.

### Advantageous Effects of Invention

According to the present disclosure, the power recovery efficiency in a supercharger of a fuel cell vehicle can be improved.

### BRIEF DESCRIPTION OF DRAWINGS

FIG. 1 is a diagram for describing a configuration of a fuel cell system according to an embodiment of the present disclosure;

FIG. 2 is a diagram for describing a configuration of a fuel cell system according to Modification 1;

FIG. 3 is a diagram for describing a configuration of a fuel cell system according to Modification 2; and

FIG. 4 is a diagram for describing a configuration of a fuel cell system according to Modification 3

### DESCRIPTION OF EMBODIMENTS

Each embodiment of the present disclosure is elaborated below with reference to the accompanying drawings. It should be noted that, detailed description of well-known matters, overlapping description of substantially the same components and the like may be omitted.

### Configuration of Fuel Cell System

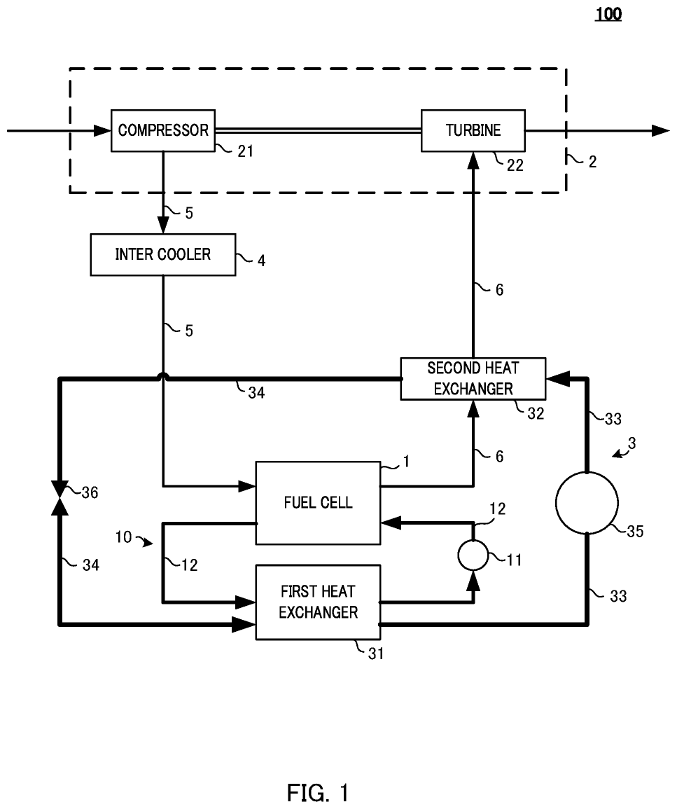

FIG. 1 is a diagram for describing a configuration of fuel cell system 100 according to an embodiment of the present disclosure. As illustrated in FIG. 1, fuel cell system 100 includes fuel cell 1, supercharger 2, heat pump apparatus 3, and inter cooler 4. In FIG. 1, the relatively thin solid line arrow indicates the flow of air, and the relatively thick solid line arrow indicates the flow of refrigerant in heat pump apparatus 3.

Fuel cell 1 generates power by causing a reaction between compressed air, and hydrogen as fuel gas. Fuel cell 1 includes a fuel cell stack composed of a stack of cells. The present disclosure assumes that fuel cell 1 is a polymer electrolyte membrane fuel cell (PEMFC) with a relatively low operation temperature. The operation temperature of fuel cell 1 in the present embodiment is about 90° C. to 100° C. Fuel cell 1 ejects, as exhaust, air containing water vapor generated through a reaction between hydrogen and oxygen in compressed air. In the present embodiment, the following description assumes that the exhaust temperature is 95° C. For fuel cell 1, the air is supplied through suction pipe 5. In addition, the exhaust of fuel cell 1 is ejected through exhaust pipe 6.

Fuel cell 1 includes pump 11 and cooling pipe 12 as cooling circuit 10. Pump 11 circulates a coolant (or a refrigerant other than water) inside cooling pipe 12. The heat generated through the reaction of fuel cell 1 is delivered by the coolant in cooling pipe 12 to first heat exchanger 31 described later, and exhausted by heat exchange with the refrigerant in heat pump apparatus 3.

Supercharger 2 recovers the energy of the exhaust of fuel cell 1 by compressing the air supplied to fuel cell 1 by using the energy of the exhaust of fuel cell 1. Supercharger 2 includes compressor 21 and turbine 22. Compressor 21 is disposed in the middle of suction pipe 5. In addition, turbine 22 is disposed in the middle of exhaust pipe 6.

Compressor 21 and turbine 22 are coaxially connected. As a result, when turbine 22 is rotated by the exhaust of fuel cell 1, compressor 21 is also rotated in unison, and thus air compression by compressor 21 is performed. In this manner, the energy of the exhaust can be recovered. Note that, a supercharger motor not illustrated in the drawing may be disposed at the shaft connecting compressor 21 and turbine 22, and compressor 21 may perform air compression with the supercharger motor being rotated by the power generated by fuel cell 1.

The air (e.g., outside air) supplied to fuel cell system 100 through suction pipe 5 is compressed by compressor 21 so as to have a high temperature, and supplied to fuel cell 1. The present embodiment assumes that when the outside air temperature is 20° C., the temperature is raised by compressor 21 to 150° C. Inter cooler 4 is disposed in the middle of suction pipe 5, and the air whose temperature is raised to 150° C. is cooled down to about 80° C. and supplied to fuel cell 1.

Heat pump apparatus 3 includes first heat exchanger 31, second heat exchanger 32, first pipe 33, second pipe 34, compressor 35, and expansion valve 36. Inside heat pump apparatus 3, a refrigerant that can evaporate at a low temperature circulates.

First heat exchanger 31 is an evaporator that absorbs the reaction heat at fuel cell 1. At first heat exchanger 31, the heat is exchanged between the refrigerant and the coolant in cooling pipe 12 of fuel cell 1, and the refrigerant absorbs heat and becomes a gas.

The outlet of first heat exchanger 31 and the inlet of second heat exchanger 32 are connected to each other through first pipe 33. Compressor 35 is provided in the middle of first pipe 33. Compressor 35 compresses the refrigerant evaporated at first heat exchanger 31 and sends it to second heat exchanger 32.

Second heat exchanger 32 is a condenser. Second heat exchanger 32 exchanges heat between the refrigerant and the exhaust from fuel cell 1 ejected through exhaust pipe 6 to raise the temperature of the exhaust. Here, the refrigerant emits heat and returns to liquid. The outlet of the second heat exchanger and the inlet of first heat exchanger 31 are connected to each other through second pipe 34. Expansion valve 36 is provided in the middle of second pipe 34. The refrigerant is expanded by expansion valve 36, and depressurized and sent to first heat exchanger 31.

As described above, heat pump apparatus 3 raises the temperature of the exhaust passing through exhaust pipe 6 with the exhaust heat of fuel cell 1 as the heat source. In this manner, the temperature of the exhaust of fuel cell 1 having passed through second heat exchanger 32 is raised to 100° C. or above, for example, about 120° C.

The exhaust whose temperature is raised by second heat exchanger 32 is supplied to turbine 22 of supercharger 2. Turbine 22 rotates with the exhaust, and rotates compressor 21 coaxially disposed. The exhaust that has rotated turbine 22 is expanded to have a low temperature and a low pressure. The present embodiment assumes that the temperature of the exhaust having passed through turbine 22 drops to around 0° C.

### Operations and Effects

With the above-mentioned configuration, fuel cell system 100 according to the embodiment of the present disclosure can raise the temperature of the exhaust of fuel cell 1 supplied to turbine 22 of supercharger 2. In this manner, the recovery efficiency of the exhaust energy in supercharger 2 can be increased.

The embodiment describes an example case where the outside air has a temperature of 20° C., the air supplied to the fuel cell 1 has a temperature of 95° C., and the exhaust of fuel cell 1 has a temperature of 95° C. Under such a temperature condition, in fuel cell system 100 of the present disclosure, the exhaust temperature is raised to 120° C. by second heat exchanger 32 of heat pump apparatus 3, and thus the exhaust has a larger energy in comparison with the case where no second heat exchanger 32 is provided. In this manner, power recovery can be more efficiently performed at turbine 22.

In addition, as the temperature of the exhaust supplied to turbine 22 increases, the temperature of the exhaust having passed through turbine 22 also increases. The exhaust from fuel cell 1 contains a large amount water vapor generated through the chemical reaction during the power generation, and therefore, if the exhaust having passed through turbine 22 has a low temperature, the moisture in the exhaust may condense and adhere to the inside of freeze exhaust pipe 6. Fuel cell system 100 according to the present embodiment can prevent the moisture in the exhaust from freezing inside exhaust pipe 6 due to the temperature rise of the exhaust having passed through turbine 22. For example, in the case where second heat exchanger 32 is not provided, i.e., the exhaust temperature is 95° C., and it is assumed that the exhaust having passed through turbine 22 has a temperature of −15° C., the temperature of the exhaust having passed through turbine 22 can be raised to about 0° C. by raising the temperature of the exhaust before being supplied to turbine 22 by the second heat exchanger 32 as in the present disclosure. In this manner, the moisture freezing of the exhaust having passed through turbine 22 can be prevented, and therefore it is not necessary to additionally provide a device such as a separator that separates and removes the moisture in the exhaust, and, fuel cell system 100 can be installed at low cost.

In addition, considering that fuel cell system 100 is mounted in a vehicle, the heat generated by the reaction of fuel cell 1 is generally exhausted by the radiator. However, as described above, in the case of a fuel cell with a relatively low operation temperature (about 100° C.), the temperature difference from the atmosphere is small and the heat dissipation efficiency is low, and therefore, it is necessary to increase the size of the radiator. Since larger radiators impose significant limitations on vehicle design and the layout of vehicle-mounted parts, downsizing is desired.

In fuel cell system 100 according to the embodiment of the present disclosure, the exhaust heat of fuel cell 1 is provided to the exhaust, and thus the heat dissipation efficiency of fuel cell 1 is correspondingly improved, making it possible to reduce the size of the radiator, or eliminate it. In this manner, the design of the vehicle and the layout of components can be more freely achieved.

Note that, the temperature of each part of fuel cell system 100 in the embodiment is an example, and the present disclosure is not limited this. For example, even in the case where the operation temperature of fuel cell 1 is further higher, the efficiency of the power recovery can be expected to be improved by raising the temperature of the exhaust before being supplied to turbine 22.

### Modifications

In fuel cell system 100 according to the above-described embodiment, the reaction heat of fuel cell 1 is used as the heat source to raise the temperature of the exhaust from fuel cell 1, but the present disclosure is not limited to this. The scope of the present disclosure includes the following modifications.

### Modification 1

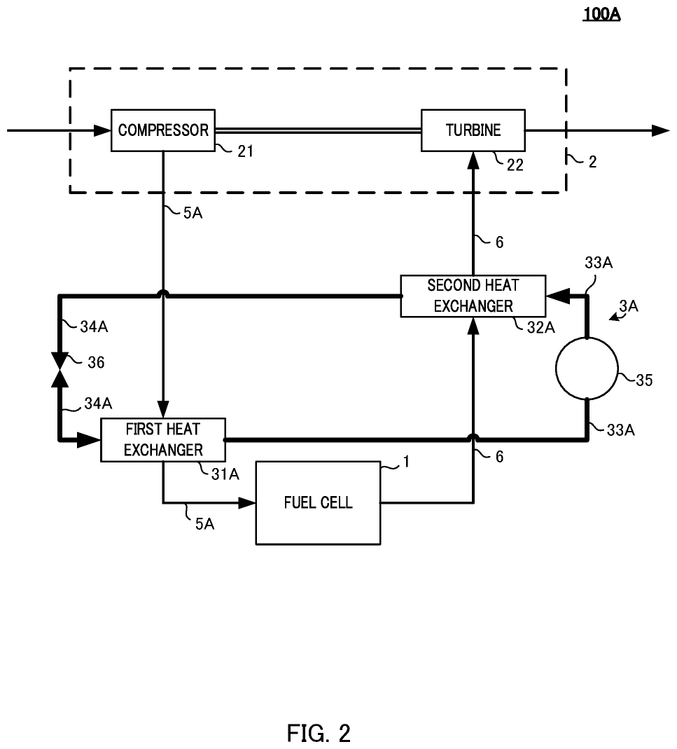

FIG. 2 is a diagram for describing a configuration of fuel cell system 100A according to Modification 1. In fuel cell system 100A, the air compressed to have a high temperature and a high pressure by compressor 21 of supercharger 2 is used as the heat source for raising the temperature of the exhaust of fuel cell 1 supplied to turbine 22. In FIG. 2, the same components as those of fuel cell system 100 illustrated in FIG. 1 are denoted with the same reference numerals, and components different from those of fuel cell system 100 illustrated in FIG. 1 are different denoted the reference numerals with “A”.

In fuel cell system 100A illustrated in FIG. 2, first heat exchanger 31A of heat pump apparatus 3A is disposed in the middle of suction pipe 5A. First heat exchanger 31A absorbs the heat from the air whose temperature is raised by compressor 21 in place of inter cooler 4 illustrated in FIG. 1. First heat exchanger 31A is connected to second heat exchanger 32A with first pipe 33A and second pipe 34A.

With this configuration, first heat exchanger 31A absorbs heat from the air whose temperature is raised (e.g., 150° C.) by compressor 21, and causes this heat to be absorbed by the exhaust of fuel cell 1 before the exhaust is supplied to turbine 22 at second heat exchanger 32A. In this manner, as in the above-described embodiment, the temperature of the exhaust before being supplied to turbine 22 is raised (e.g., 120° C.), and the power recovery efficiency in supercharger 2 can be improved, and, the moisture freezing of the exhaust after the power recovery at turbine 22 can be prevented.

### Modification 2

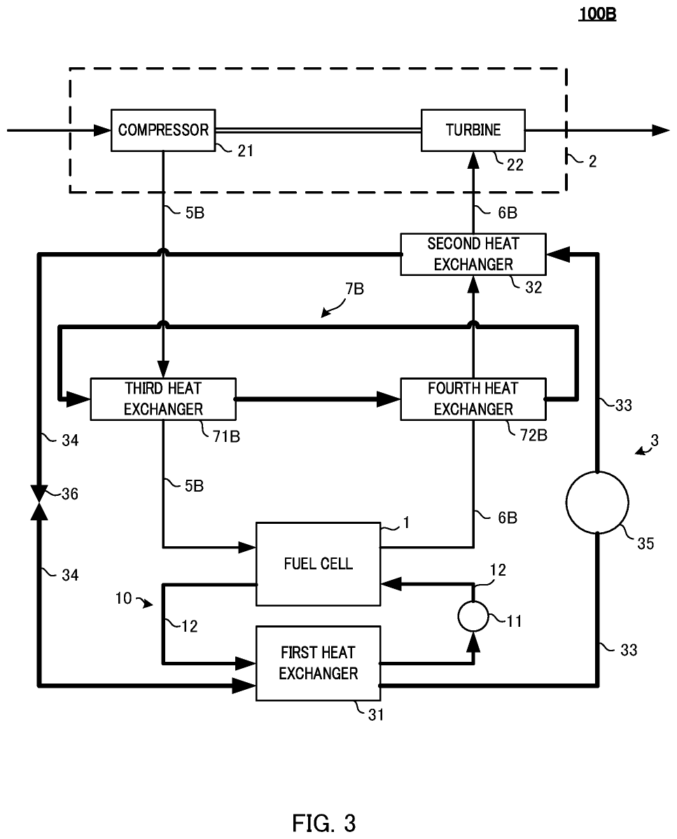

FIG. 3 is a diagram for describing a configuration of fuel cell system 100B according to Modification 2. Fuel cell system 100B uses both the reaction heat of fuel cell 1 and the air compressed to have a high temperature by compressor 21 of supercharger 2, as the heat source for raising the temperature of the exhaust from fuel cell 1.

As illustrated in FIG. 3, fuel cell system 100B includes, in addition to the heat pump apparatus 3 as that illustrated in FIG. 1, second heat pump apparatus 7B including third heat exchanger 71B provided in the middle of suction pipe 5B and fourth heat exchanger 72B provided in the middle of exhaust pipe 6B.

The outside air is compressed to have a high temperature and a high pressure by compressor 21 of supercharger 2, and thereafter the heat thereof is absorbed at third heat exchanger 71B. The same refrigerant as that of heat pump apparatus 3 is provided in the pipe connecting fourth heat exchanger 72B and third heat exchanger 71B of second heat pump apparatus 7B, and the heat absorbed at third heat exchanger 71B is absorbed by the exhaust of fuel cell 1 before being supplied to turbine 22 at fourth heat exchanger 72B.

On the other hand, as in the above-described embodiment, by second heat exchanger 32 of heat pump apparatus 3, the reaction heat of fuel cell 1 is also absorbed by the exhaust of fuel cell 1 before being supplied to turbine 22.

With this configuration, the temperature of the exhaust before being supplied to turbine 22 is raised, the power recovery efficiency in supercharger 2 can be improved, and the moisture freezing of the exhaust after the power recovery at turbine 22 can be prevented.

Note that, in the example illustrated in FIG. 3, in exhaust pipe 6B, fourth heat exchanger 72B of second heat pump apparatus 7B is closer to fuel cell 1 than second heat exchanger 32 of heat pump apparatus 3. The present disclosure is not limited to this arrangement, and second heat exchanger 32 may be closer to fuel cell 1 than fourth heat exchanger 72B, for example. Even in this case, as in the example illustrated in FIG. 3, the power recovery efficiency at supercharger 2 can be improved, and the moisture freezing of the exhaust after the power recovery at turbine 22 can be prevented.

### Modification 3

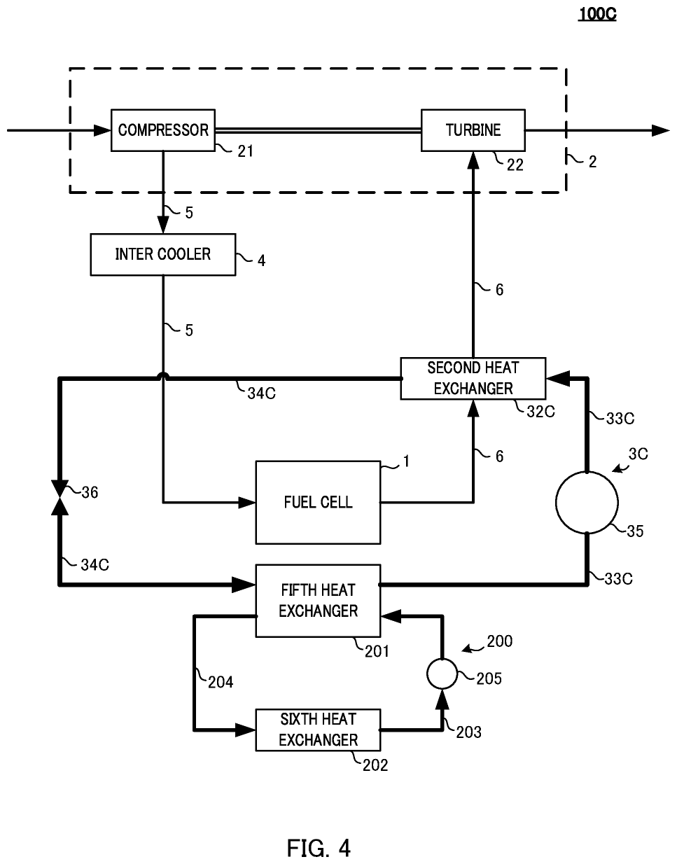

FIG. 4 is a diagram for describing a configuration of fuel cell system 100C according to Modification 3. Modification 3 assumes that fuel cell system 100 is mounted in a vehicle, such as a truck, especially a vehicle with other heat exchange systems, such as a refrigerated vehicle. In fuel cell system 100C, heat exchange system 200 mounted in the vehicle and independent of fuel cell 1 is used as the heat source for raising the temperature of the exhaust from fuel cell 1.

Heat exchange system 200 includes fifth heat exchanger 201 and sixth heat exchanger 202. Fifth heat exchanger 201 and sixth heat exchanger 202 are connected to each other through pipes 203 and 204. Pump 205 for circulating the refrigerant is installed in the middle of pipe 203. In addition, fifth heat exchanger 201 is connected to second heat exchanger 32C through first pipe 33C and second pipe 34C in heat pump apparatus 3C in place of first heat exchanger 31 of heat pump apparatus 3 in FIG. 1.

With this configuration, the heat absorbed at sixth heat exchanger 202 is absorbed by the refrigerant of heat pump apparatus 3C at fifth heat exchanger 201, and is provided to the exhaust of fuel cell 1 before being supplied to turbine 22 at second heat exchanger 32C. In this manner, as in the above-described embodiment, the temperature of the exhaust before being supplied to turbine 22 can be raised, and the moisture freezing of the exhaust after the power recovery at turbine 22 can be prevented.

### INDUSTRIAL APPLICABILITY

The present disclosure is suitable for a fuel cell system including a supercharger.

1. A fuel cell system comprising:
a fuel cell;
a supercharger configured to increase a pressure of intake air of the fuel cell by rotating a turbine with an exhaust of the fuel cell; and
a heat pump apparatus configured to absorb heat from a predetermined heat source to increase a temperature of the exhaust supplied to the turbine.

2. The fuel cell system according to claim 1, wherein the heat pump apparatus includes a first heat exchanger configured to absorb a reaction heat of the fuel cell, and a second heat exchanger configured to cause the exhaust to absorb heat.

3. The fuel cell system according to claim 1, further comprising a cooling circuit configured to circulate coolant for cooling down the fuel cell,
wherein the heat pump apparatus includes a first heat exchanger configured to absorb heat from the coolant having performed cooling of the fuel cell, and a second heat exchanger configured to cause the exhaust to absorb heat.

4. The fuel cell system according to claim 2, further comprising a second heat pump apparatus including a third heat exchanger configured to absorb heat from intake air of the fuel cell whose temperature is raised by the supercharger, and a fourth heat exchanger configured to cause the exhaust to absorb heat.

5. The fuel cell system according to claim 1, wherein the heat pump apparatus includes a first heat exchanger configured to absorb heat from intake air of the fuel cell whose temperature is raised by the supercharger, and a second heat exchanger configured to cause the exhaust to absorb heat.

6. A vehicle equipped with the fuel cell system according to claim 1.
